(19) United States
(12) Patent Application Publication
(10) Pub. No.: US 2015/0096857 A1
(43) Pub. Date: Apr. 9, 2015

(54) STATOR ASSEMBLY WITH INNER RACE PILOT RING

(71) Applicant: SCHAEFFLER TECHNOLOGIES GMBH & CO. KG, Herzogenaurach (DE)

(72) Inventors: Jacob Rufener, Rittman, OH (US); Markus Steinberger, Macedonia, OH (US); Michael Resh, Massillon, OH (US); David Burky, JR., Massillon, OH (US); Patrick Lindemann, Wooster, OH (US)

(73) Assignee: SCHAEFFLER TECHNOLOGIES GMBH & CO. KG, Herzogenaurach (DE)

(21) Appl. No.: 14/496,128

(22) Filed: Sep. 25, 2014

Related U.S. Application Data
(60) Provisional application No. 61/886,640, filed on Oct. 3, 2013.

(51) Int. Cl. F16H 45/02; F16D 33/18; F16D 11/16

(52) U.S. Cl. CPC F16H 45/02; F16D 11/16; F16D 33/18
USPC 192/3.25

(57) ABSTRACT

A stator assembly for a torque converter includes a housing, a blocking element, an inner race, and a first ring. The housing includes a plurality of stator blades, a central axis, and a pocket. The blocking element is disposed in the pocket and is pivotable about an axis parallel to the central axis. The inner race includes an outer notch for engaging the blocking element, an inner spline for engaging a transmission shaft, and a first outer piloting surface. The first ring is for radially positioning the housing on the inner race first outer piloting surface. In some example embodiments, the housing includes a bore and the first ring is pressed into the housing bore. In some example embodiments, the housing includes a radially extending surface in contact with the first ring. In an example embodiment, the radially extending surface limits axial displacement of the inner race.

### FIELD

The invention relates generally to a torque converter stator assembly, and more specifically to a torque converter stator assembly with an inner race pilot ring.

### BACKGROUND

A stator assembly with a rocker one-way brake, or clutch, is known. One example is shown in United States Patent Publication No. 2013/0213027 to Bird et al, hereby incorporated by reference.

### BRIEF SUMMARY

Example aspects broadly comprise a stator assembly for a torque converter including a housing, a blocking element, an inner race, and a first ring. The housing includes a plurality of stator blades, a central axis, and a pocket. The blocking element is disposed in the pocket and is pivotable about an axis parallel to the central axis. The inner race includes an outer notch for engaging the blocking element, an inner spline for engaging a transmission shaft, and a first outer piloting surface. The first ring is for radially positioning the housing on the inner race first outer piloting surface. In some example embodiments, the housing includes a bore and the first ring is pressed into the housing bore. In some example embodiments, the housing includes a radially extending surface in contact with the first ring. In an example embodiment, the radially extending surface limits axial displacement of the inner race.

In some example embodiments, the stator assembly includes a side plate for retaining the blocking element in the pocket. In an example embodiment, the side plate is fixed to the housing by staking In an example embodiment, the side plate limits axial displacement of the inner race. In some example embodiments, the side plate includes the first ring. In an example embodiment, the stator assembly includes a second ring, integral with the housing. The inner race includes a second outer piloting surface and the second ring is for radially positioning the housing on the second outer piloting surface.

In some example embodiments, the stator assembly includes a second ring. The first and second rings are integral with the housing. The inner race includes a second outer piloting surface. The second ring is for radially positioning the housing on the second outer piloting surface. In some example embodiments, the inner race includes an integral side plate for retaining retaining the blocking element in the pocket. In an example embodiment, the inner race is axially retained by a snap ring installed in a housing groove.

### BRIEF DESCRIPTION OF THE DRAWINGS

The nature and mode of operation of the present invention will now be more fully described in the following detailed description taken with the accompanying drawing figures, in which:

FIG. 1 is a front view of a first embodiment of a stator assembly with a side plate removed for clarity according to an example aspect;

FIG. 2 is a section view of the stator assembly of FIG. 1 taken generally along line 2-2 in FIG. 1;

FIG. 3 is a section view of a second embodiment of a stator assembly according to an example aspect;

FIG. 4 is a section view of a third embodiment of a stator assembly according to an example aspect.

3.

[symbol]

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

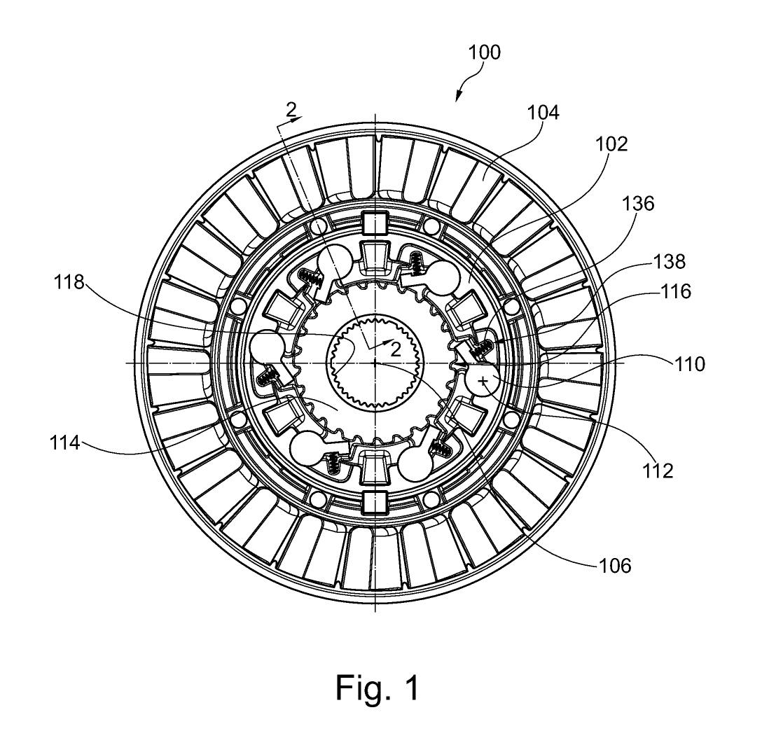

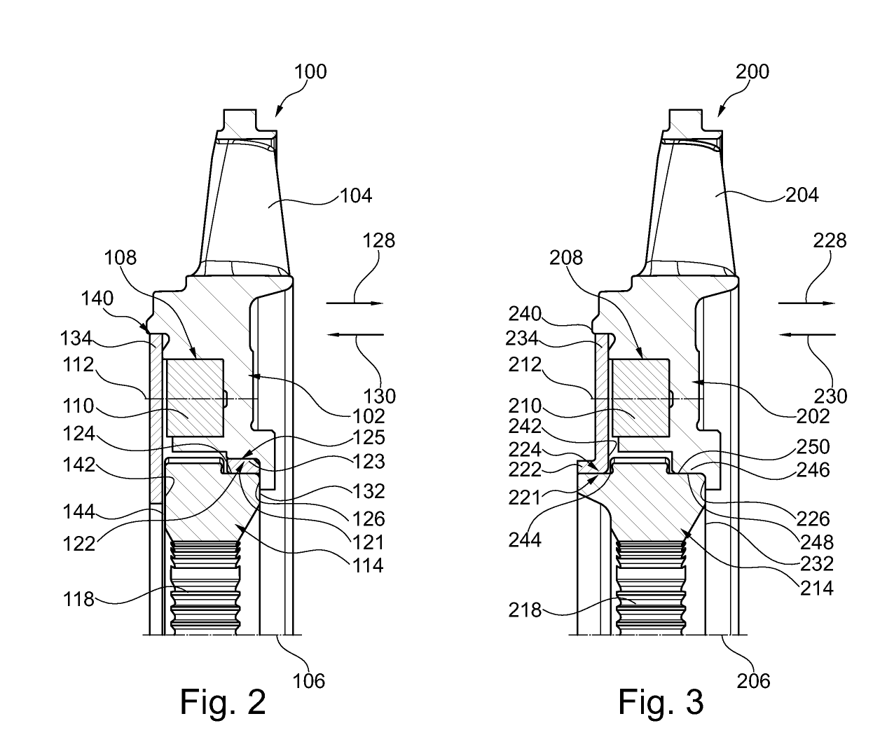

The following description is made with reference to FIGS. 1-2. FIG. 1 is a front view of stator assembly 100 with a side plate removed for clarity. FIG. 2 is a section view of stator assembly 100 of FIG. 1 taken generally along line 2-2 in FIG. 1. Stator assembly 100 includes housing 102 including a plurality of stator blades 104, central axis 106, and pocket 108. Blocking element 110 is disposed in the pocket and pivotable about axis 112 parallel to central axis 106. Inner race 114 includes outer notch 116 for engaging the blocking element, inner spline 118 for engaging a transmission shaft (not shown), and outer piloting surface 120. Stator assembly 100 also includes ring 122. In an example embodiment, the housing is manufactured from aluminum and the ring is manufactured from steel. The inner race may be manufactured from powdered metal or may be a hardened steel forging, for example.

Ring 122 is for radially positioning housing 102 on outer piloting surface 120. That is, the ring includes inner circumferential surface 121 engaged with the piloting surface and outer circumferential surface 123 engaged with circumferential surface 124 of housing bore 125. Ring 122 is pressed into the housing bore. That is, the ring and the bore have an interference fit and the ring must be installed with the use of force into the housing. Housing 102 includes radially extending surface 126 in contact with ring 122. Surface 126 limits axial displacement of the inner race. Otherwise stated, when the inner race is urged in direction of arrow 128 or when the housing is urged in direction of arrow 130, contact between surface 126 and surface 132 of the inner race limits relative axial displacement of the two components.

Stator assembly 100 includes side plate 134 for retaining the blocking element in the pocket. In an example embodiment, the stator assembly includes spring 136 for urging the blocking element into contact with the inner race and the side plate also retains the spring within recess 138 of the housing. In an example embodiment the side plate is fixed to the housing by staking 140. Side plate 134 limits axial displacement of inner race 114 through contact between surfaces 142 and 144.

Ring 122 improves durability of the stator assembly. Due to the design of the rocker clutch, or rocker brake, only a single rocker may be positioned within a notch of the inner race when the clutch is in a locked condition. The reaction force from the rocker acting on the inner race urges the inner race to contact the housing opposite to the rocker location. The concentrated force from the hardened inner race against the softer, less dense, machined aluminum housing pilot surface can deform and/or wear the housing, leading to contamination. By pressing a harder, steel ring into the housing, the force from the inner race is more evenly distributed about the housing bore and the inner race will not deform the ring. Although ring 122 is shown as pressed into housing 102, other methods of fixing to the two components are possible. For example, the ring may be added to the housing during a casting process.

The following description is made with reference to FIG. 3. FIG. 3 is a section view of stator assembly 200. The above description of FIG. 2 with 1XX reference numerals is generally applicable to FIG. 3 with 2XX reference numerals except as described below. Side plate 234 includes ring 222. That is, the side plate includes cylindrical protrusion 222 extending from surface 242 that includes surface 224 engaged with surface 221 of inner race 214. Housing 202 includes integral ring 246 with circumferential surface 248 Inner race 214 includes circumferential surface 250 engaged with surface 248. That is, ring 246 is for radially positioning the housing on surface 250. In an example embodiment, the side plate is manufactured from steel or anodized aluminum.

Durability of stator assembly 200 is improved in a similar manner as described for assembly 100 above. Though the side plate with integral ring is not pressed into the housing as above, the side plate and additional, integral ring combine to improve durability of the stator assembly. That is, the side plate ring and housing ring effective double-center the inner face, distributing the reaction force between the two components.

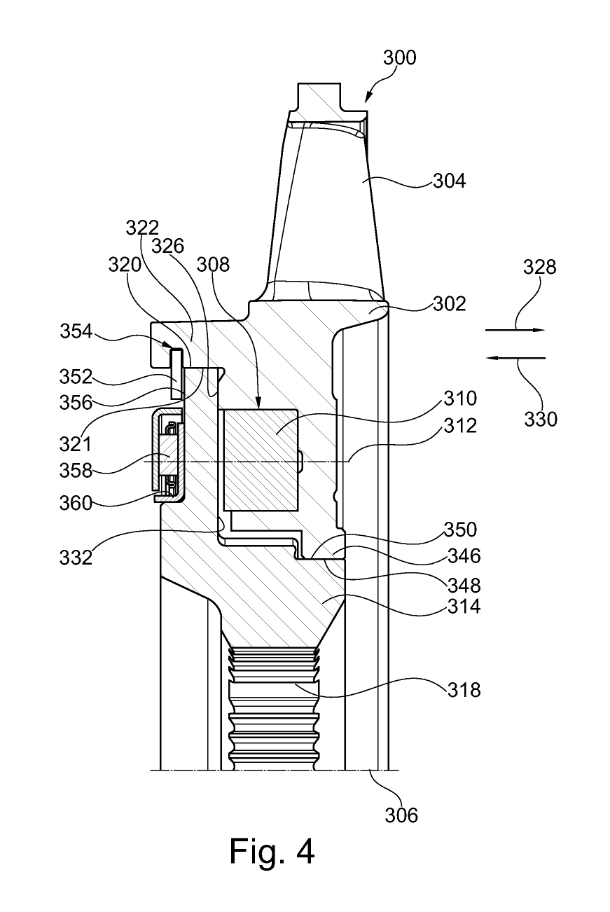

The following description is made with reference to FIG. 4. FIG. 4 is a section view of stator assembly 300. Stator assembly 300 includes housing 302 including a plurality of stator blades 304, central axis 306, and pocket 308. Blocking element 310 is disposed in the pocket and pivotable about axis 312 parallel to central axis 306 Inner race 314 includes an outer notch (not shown), similar to notch 116 in FIG. 1, for engaging the blocking element. Race 314 also includes inner spline 318 for engaging a transmission shaft (not shown) and outer piloting surface 320 and 350. The housing is manufactured from aluminum and the inner race may be manufactured from powdered metal or may be a hardened steel forging, for example.

Housing 302 includes rings 322 and 346 for positioning the housing on respective outer piloting surfaces 320 and 350. That is, the rings include respective inner circumferential surfaces surfaces 321 and 348 engaged with the piloting surfaces. Rings 322 and 346 are integral with the housing. Housing 302 includes radially extending surface 326, and snap ring 352 installed in housing notch 354 for limiting axial displacement of the inner race. Otherwise stated, when the inner race is urged in direction of arrow 328 or when the housing is urged in direction of arrow 330, contact between surface 326 and surface 332 of the inner race limits relative axial displacement of the two components. Similarly, when the inner race is urged in direction of arrow 330 or when the housing is urged in direction of arrow 328, contact between snap ring 352 and surface 356 of the inner race limits relative axial displacement of the two components.

Inner race 314 includes integral side plate 334 for retaining the blocking element in the pocket. In an example embodiment, the stator assembly includes a spring (not shown), similar to spring 136 in FIG. 1, for urging the blocking element into contact with the inner race and the side plate also retains the spring within a housing recess. Axial thrust bearing 358 is radially positioned by inner race circumferential surface 360 and axially positioned against surface 356.

Durability of stator assembly 300 in FIG. 4 is improved by distributing a force from the inner race over two integral rings. The rings combine to increase the area in contact with the inner race, reducing stress. Furthermore, the area is even larger because one of the housing rings is located at a large radius.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A stator assembly for a torque converter comprising:
a housing including a plurality of stator blades, a central axis, and a pocket;
a blocking element disposed in the pocket and pivotable about an axis parallel to the central axis;
an inner race including an outer notch for engaging the blocking element, an inner spline for engaging a transmission shaft, and a first outer piloting surface; and,
a first ring for radially positioning the housing on the inner race first outer piloting surface.

2. The stator assembly of claim 1 wherein the housing includes a bore and the first ring is pressed into the housing bore.

3. The stator assembly of claim 2 wherein the housing includes a radially extending surface in contact with the first ring.

4. The stator assembly of claim 3 wherein the radially extending surface limits axial displacement of the inner race.

5. The stator assembly of claim 1 further comprising a side plate for retaining the blocking element in the pocket.

6. The stator assembly of claim 5 wherein the side plate is fixed to the housing by staking

7. The stator assembly of claim 5 wherein the side plate limits axial displacement of the inner race.

8. The stator assembly of claim 5 wherein the side plate includes the first ring.

9. The stator assembly of claim 8 further comprising a second ring, integral with the housing, wherein the inner race includes a second outer piloting surface and the second ring is for radially positioning the housing on the second outer piloting surface.

10. The stator assembly of claim 1 further comprising a second ring, wherein:
the first and second rings are integral with the housing;
the inner race includes a second outer piloting surface; and,
the second ring is for radially positioning the housing on the second outer piloting surface.

11. The stator assembly of claim 10 wherein the inner race includes an integral side plate for retaining retaining the blocking element in the pocket.

12. The stator assembly of claim 11 wherein the inner race is axially retained by a snap ring installed in a housing groove.
